(19) United States
(12) Patent Application Publication
(10) Pub. No.: US 2020/0408566 A1
(43) Pub. Date: Dec. 31, 2020

(54) Automatic Diagnostics Generation in Building Management

(71) Applicant: Aquicore, Inc., Washington, DC (US)

(72) Inventors: Minkyung Kang, Seoul (KR); Michael Donovan, Annandale, VA (US); Logan Soya, Washington, DC (US)

(21) Appl. No.: 16/858,242

(22) Filed: Apr. 24, 2020

Related U.S. Application Data
(60) Provisional application No. 62/867,859, filed on Jun. 27, 2019.

(51) Int. Cl. G01D 4/00; G06K 9/62; G16Y 10/80; G16Y 20/30; G16Y 40/20

(52) U.S. Cl. CPC G01D 4/002; G06K 9/6223; G16Y 40/20; G16Y 20/30; G16Y 10/80

(57) ABSTRACT

Automatic diagnostics of a building is provided. Computer-implemented methods, systems, platforms and devices are provided to optimize building management including energy usage. Aspects and features in embodiments include note topic clustering, machine learning and optimization algorithm development, automatic issue detection and categorization, customizable issue detection and categorization, and automatic note generation. Scalable self-learning systems and methods for building operation and management are also provided. A system creates a generic anomaly detection and classification machine learning model based on a general training dataset, deploys the model in a cloud server, and creates a copy of the model for each individual building/equipment/device of a user. The system further detects and classifies anomalies from real-time sensor data based off of the model. In a further feature, the system continuously updates the model based on a user's feedback about the detection and classification.

### FIELD

The technical field of the present disclosure relates to energy monitoring and control.

### BACKGROUND ART

Managing energy usage in buildings is increasingly important in a variety of applications. Owners and residents of commercial buildings, residential buildings, and government buildings often wish to use energy in their building efficiently to reduce cost and ameliorate climate change. A building manager is often tasked with setting and controlling energy usage in a building. This can involve checking energy usage at a particular building based on monthly billing or readouts from meters or sensors installed at the building. Some buildings may even have a network of sensors as part of an energy management platform to provide data regarding energy usage in a building. For example, an energy management platform provided by Aquicore Inc. allows a building manager to monitor energy usage and manage energy usage based on a network of sensors that provide metering and submetering for a building. These networks of sensors can even provide data in real-time to a building manager about energy usage detected by the sensors.

However, the burden of managing energy usage still falls largely on a building manager. Even with more robust data on energy usage occurring within a building, such as the amount of energy used at different times of the day by the building or by different equipment in the building, a building manager still must manage energy usage in a variety of situations. These situations may involve, for example, equipment start/stop times, equipment failure or replacement, changes in season or weather, different types of building use, changes in building occupancy or type of activity by building residents. These situations and events as they arise have a major impact on energy usage in a building.

Conventional energy management platforms though often do not even account for such situations or provide limited control options generally set at initialization. Some platforms only allow a building manager or administrator to create a building profile to control energy usage for the building. The control profile may include a start and stop time to govern when building equipment such as an air conditioning system is turned off or on at the beginning or end of a day.

One approach building engineers have taken is to inspect and take notes about building energy usage. For example, building engineers may walk around in their buildings, check issues, and take notes about it with a pen and paper. This note taking includes any type of knowledge about the building ranging from equipment failure/malfunctioning to energy savings measure applied to the building. Building engineers may have meetings with property managers or chief engineers on a regular basis, review the notes they have taken, and evaluate the building performance.

Once an issue is found that needs a fix, engineers identify a root cause and resolve it by manually changing equipment setups. For instance, if an engineer finds a building starting up too early, she checks equipment settings and changes the existing startup time to a new startup time he thinks is appropriate. If an engineer finds an unscheduled equipment run, she checks if there is any building management system (BMS) glitch, and fixes it with a new setting.

There are a number of problems with the existing approaches to managing energy. Hand written notes are seldom combined or synthesized with sensor data and a lot of useful information to understand the issue is ignored. Information is not compiled in one place and gets lost with workforce changes, making it hard to reference the issue in the future. Building engineers have to spend years to learn about a new building. Optimizations to a BMS are being made based on building engineer's knowledge which is different from engineer to engineer. Issues can be easily missed as they are not continuously monitored. These limitations can negatively impact energy usage, building performance, and the enjoyment and satisfaction of a resident or owner with a building.

What is needed are methods, systems, and approaches to overcome the above problems and allow improved optimizations to building management including energy usage.

### BRIEF SUMMARY

The present disclosure overcomes the above problems. Embodiments of the present disclosure provide an automatic diagnostics of a building. Computer-implemented methods, systems, platforms and devices are provided to optimize building management including energy usage. Aspects and features in embodiments include note topic clustering, machine learning algorithm development for anomaly detection and categorization, automatic anomaly detection and categorization, automatic note generation, and continuous improvement of the anomaly detection and categorization algorithm through user feedback and customization.

In further features, continuous learning and crowdsourcing of user data is applied to the management of buildings. Machine-learning is used to detect anomalies and generate real-time recommendations. The recommendations prompt automated workflows. Actions or input from users create further feedback to reinforce accuracy and generate new recommendations for building management.

Further embodiments, features, and advantages of this invention, as well as the structure and operation and various embodiments of the invention, are described in detail below with reference to accompanying drawings.

### BRIEF DESCRIPTION OF THE DRAWINGS/FIGURES

The patent or application file contains at least one drawing executed in color. Copies of this patent or patent application publication with color drawing(s) will be provided by the Office upon request and payment of the necessary fee.

The accompanying drawings, which are incorporated herein and form part of the specification, illustrate the present disclosure and, together with the description, further serve to explain the principles of disclosure and to enable a person skilled in the relevant art to make and use the disclosure.

FIG. 1 shows an overview of a computer-implemented scalable self-learning process for building operation and management according to an embodiment.

FIG. 2 shows an overall scalable self-learning process for building operation and management according to an embodiment.

FIG. 3 shows a technical architecture for carrying out the overall scalable self-learning process of FIG. 2 for building operation and management according to an embodiment.

FIG. 4 is a flowchart diagram of a scalable self-learning method for building operation and management according to an embodiment.

FIG. 5 is a diagram that illustrates an example note according to an embodiment.

FIG. 6 is a flowchart diagram that illustrates an example process for automated note taking clustering based on machine learning according to an embodiment.

FIG. 7 is a diagram that illustrates an example of note text vectorization according to an embodiment.

FIG. 8 is a color diagram that illustrates an example result of note topic clustering according to an embodiment.

FIG. 9 is a diagram that illustrates pre-trained classifier generation according to an embodiment.

FIG. 10 is a diagram that illustrates anomaly detection according to an embodiment.

FIG. 11 is a diagram that illustrates a cause prediction according to an embodiment.

FIG. 12 is a diagram that illustrates providing user feedback according to an embodiment.

FIG. 13 is a diagram that illustrates retraining of a classifier according to an embodiment.

FIG. 14 is a diagram that illustrates an example classifier and data input and output.

FIG. 15 shows a table of example used features according to type and feature.

FIG. 16 shows an example random forest classifier.

FIG. 17 shows an example of classification test results.

FIG. 18 shows an example of user feedback in operation.

FIG. 19 shows an example display panel providing information to a user about an anomaly detected with automated anomaly detection.

FIG. 20 shows a display panel providing a dashboard view of a list of activities including a run having an anomaly detected with automated anomaly detection.

FIG. 21 shows an example display panel displaying information on a run selected from the dashboard view of FIG. 20.

FIG. 22 shows two example display panels that enable a user to input an action to update an issue cause associated with the run displayed in FIG. 21.

The drawing in which an element first appears is typically indicated by the leftmost digit or digits in the corresponding reference number. In the drawings, like reference numbers may indicate identical or functionally similar elements.

### DETAILED DESCRIPTION OF EMBODIMENTS

The present disclosure describes new approaches to building operation optimization. Building optimizations are obtained with machine learning (also referred to herein as automatic diagnostics).

### Automatic Diagnostics

In an embodiment, there are three steps for automatic diagnostics: first, collect all human inputs (notes, comments, work orders, etc.) and sensor data (utility metering, equipment submetering, environment monitoring, etc.). Second, combine them and draw insights on the highest leverage optimizations being performed in the building and develop a model to automatically diagnose issues and suggest optimal ways for users to operate their facilities by applying machine learning techniques.

Embodiments of the present disclosure provide a new and improved automatic diagnostic of a building. Computer-implemented methods, systems, platforms and devices are provided to optimize building management including energy usage. Aspects and features in embodiments include note topic clustering, machine learning algorithm development for anomaly detection and categorization, automatic anomaly detection and categorization, automatic note generation, and continuous improvement of the anomaly detection and categorization algorithm through user feedback and customization.

In this way, systems and methods of automatic diagnostics can achieve the following major benefits:
Knowledge about buildings grows with more notes and sensor data and more rich insights can be drawn by combining them,
The knowledge is maintained in a central repository and continuously utilized/referenced by multiple engineers in the future,
Buildings can self-learn and self-diagnose any issue without human intervention,
Issues can be solved faster with auto-detection and diagnosis process, and
Issues are not missed as it is continuously monitored in real-time.

### Continuous Machine Learning and Crowdsourcing

In a further feature, scalable self-learning systems and methods for building operation and management are provided. A system creates a generic anomaly detection and classification machine learning model based on a general training dataset, deploys the model in a cloud server, and creates a copy of the model for each individual building/equipment/device of a user. The system detects and classifies anomalies from real-time sensor data based off of the model. In an embodiment, the system continuously updates the model based on a user's feedback about the detection and classification. In this way, the system optimizes the model tailored to a specific building/equipment/device based on building engineers' knowledge about their systems while utilizing the initial generic guidance that is obtained from a larger building usage pattern pool.

Advantages provided in embodiments include, but are not limited to, the following:
automatic and real-time detection and classification of anomalies;
continuous update of the machine model using user feedback to learn building/meter/device specific anomaly pattern;
crowdsourcing of engineering knowledge; and
help building engineers and property managers to find issues, troubleshoot, and optimize the building operation and management.

Embodiments refer to illustrations described herein with reference to particular applications. It should be understood that the invention is not limited to the embodiments. Those skilled in the art with access to the teachings provided herein will recognize additional modifications, applications, and embodiments within the scope thereof and additional fields in which the embodiments would be of significant utility.

In the detailed description of embodiments that follows, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

### Scalable Self-Learning Systems and Methods

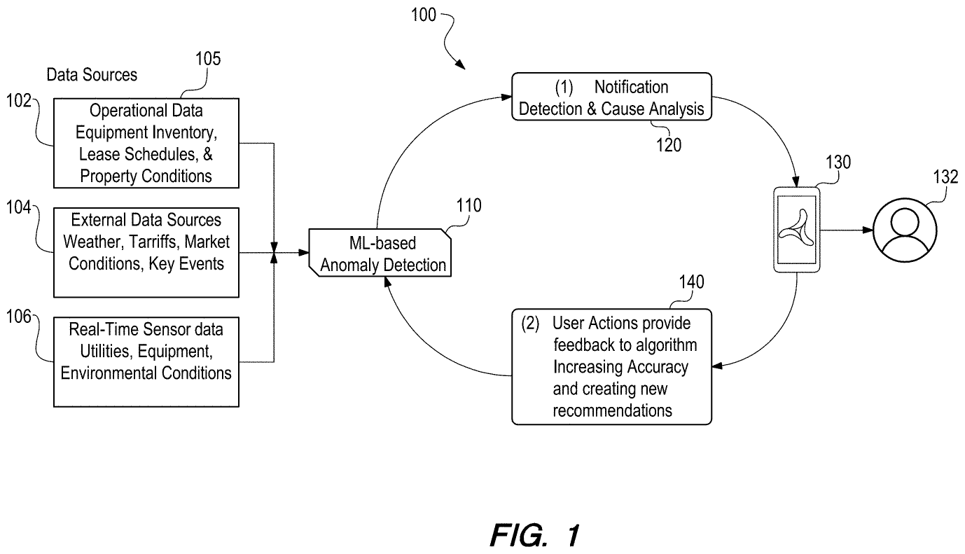

FIG. 1 shows a scalable self-learning method 100 for building operation and management according to an embodiment (steps 110-140). Method 100 is computer-implemented on one or more computing devices coupled over one more data networks. Method 100 uses machine learning (ML)-based anomaly detection to generate real-time recommendations and prompt automated business workflows. User actions create feedback to reinforce accuracy and generate new recommendations.

In step 110, anomalies are detected using machine-learning. ML-based anomaly detection may analyze input data from data sources 105 to detect anomalies. Data sources 105 can provide operational data 102, external data 104 and/or real-time sensor data 106. For example, operational data 102 may include equipment inventory, lease schedules, and/or property conditions. External data sources 105 may input to system 100 external data 104, such as, weather, tariffs, market conditions, and/or key events. Data sources 105 may also include sensors to input sensor data in real-time to system 100. Real-time sensor data 106 may include sensor data relating to utilities, equipment, and/or environmental conditions.

When ML-based anomaly detection detects one or more anomalies, notifications are generated (step 120). A cause analysis may be performed to determine one or more causes associated with a detected anomaly. These notifications can then be sent to a user computing device. In step 120, notifications sent to a user computing device may include information identifying a detected anomaly and/or cause analysis associated with the detected anomaly. Other identifying or pertinent data relevant to the detected anomaly may be included in a notification as desired. In step 130, a user 132 operating a mobile device may interact through a user-interface to provide a user action.

In step 140, one or more user actions may be used to provide feedback for the ML-based anomaly detection. Feedback in step 140 may include, but is not limited to, data related to a machine learning algorithm and classifier used in ML-based anomaly detection in step 110 to increase accuracy and create new recommendations.

In embodiments, method 100 is computer-implemented. One or more computing devices may be used to carry out machine learning (ML)-based anomaly detection (step 110), notification generation (step 120), and receipt of feedback (step 140). For example, one or more processors at a remote server over a network as part of a cloud-based service may be used to implement system 100 including machine learning (ML)-based anomaly detection (step 110), notification generation (step 120), communicating with web app or mobile device (step 130), and receiving feedback (step 140). The one or more processors at a remote server may be coupled to data sources 105 and one or more user computing devices 130. Web-based data storage (also called cloud storage) may be used to store data for access during method 100. A user computing device 130 may be any computing device that can be used by a user to provide data communication. Data communication may be carried out directly or indirectly with to the one or more processors at a remote server and may be part of communication through a web service and/or a cloud storage service.

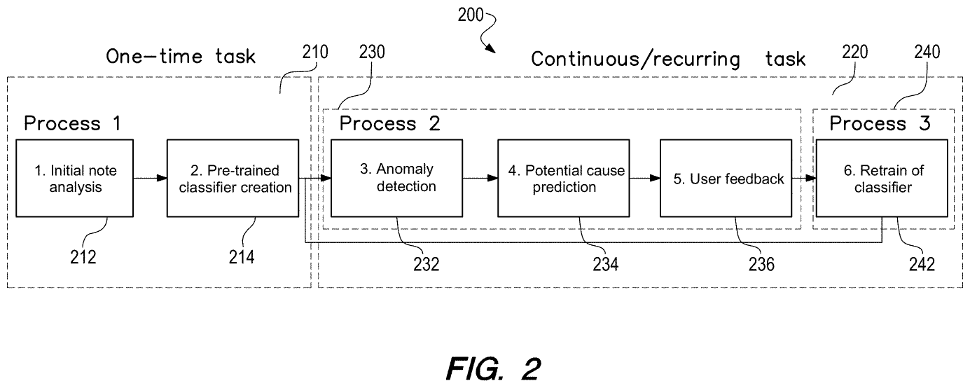

Additional description of processes and a technical architecture for scalable self-learning with ML-based anomaly detection, notification, and feedback is described further below with respect to FIGS. 2-22.

FIG. 2 shows an overall scalable self-learning process 200 for building operation and management according to an embodiment. Process 200 includes an initial or one-time task 210 (process 1) and a continuous or recurring task 220 (processes 230 and 240, also referred to as processes 2 and 3). One-time task 210 includes initial note analysis 212 and pretrained classifier creation 214. Continuous or recurring task 220 includes issue detection 232, potential cause prediction 234, and obtaining user feedback 236 (process 230). Task 220 also includes classifier retraining 242 (process 240).

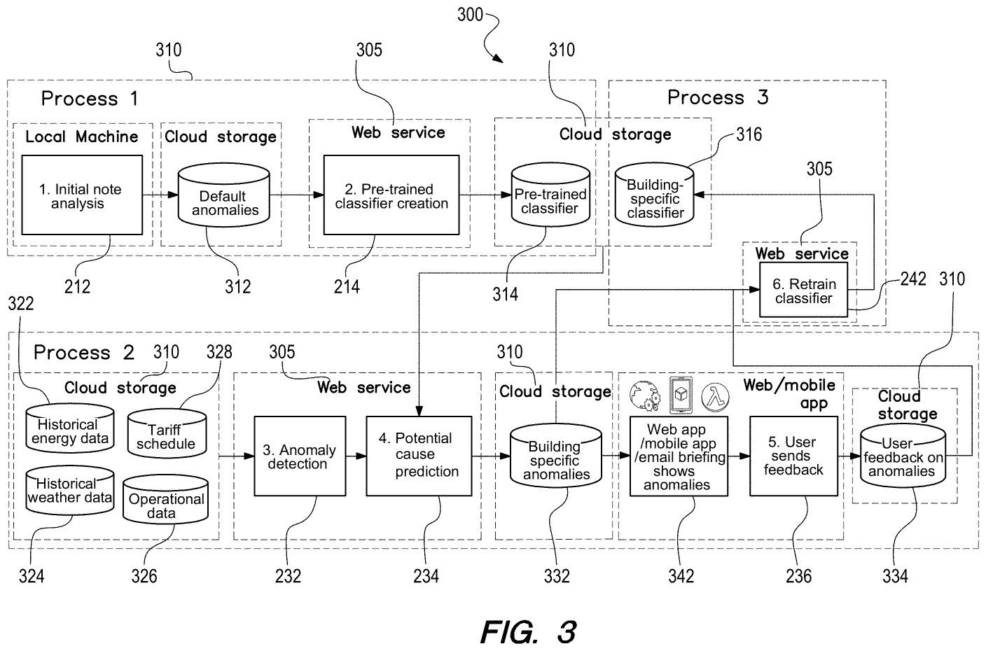

FIG. 3 shows a technical architecture for a system 300 for carrying out the overall scalable self-learning process 200 of FIG. 2 for building operation and management according to an embodiment. As shown in FIG. 3, computer-implemented tasks or processes may be carried out locally or as part of a web service 305. Data storage also may be carried out locally or remotely as part of a cloud storage service 310. In the example shown in FIG. 3 not intended to be limiting, initial note analysis 212 may be performed on a local computing device coupled over a network to access a database 312. Database 312 stores data on default anomalies. Database 312 may be located in cloud storage 310.

Pre-trained classifier creation 214 may be performed as part of web service 305. Pre-trained classifier creation 214 may also communicate with a pre-trained classifier database 314. Pre-trained classifier database 314 stores data on one or more pre-trained classifiers created by pre-trained classifier creation 214. Pre-trained classifier database 314 may be located in cloud storage 310.

Aspects of process 2 may also be implemented in a web service 305 and cloud storage 310. As shown in FIG. 3, issue detection 232 (also referred to as anomaly detection) and potential cause prediction 234 may be performed as part of web service 305. Issue detection 232 may be coupled to receive input data from data sources. This may include data in remote databases 322-328 in cloud storage 310. Database 322 may have historical energy data. Database 324 may have historical weather data. Database 326 may have operation data. Database 328 may have a tariff schedule.

Potential cause prediction 234 may be coupled to output data to a database 332. Database 332 may store data on building specific anomalies. Potential cause prediction 234 may also access data in pre-trained classifier database 314 and a building specific classifier 316 both of which may be located in cloud storage 310.

An anomaly show operation 342 may be carried out to show one or more anomalies to a user. This may include a web application, mobile application, email briefing, or other mode for communicating with a user. A user feedback operation 236 allows a user to input feedback for storage in a database 334. Database 334 store feedback from one or more users and may also be part of cloud storage 310.

Aspects of process 3 may also be implemented in a web service 305 and cloud storage 310. Retraining classifier operation 242 may be carried out as part of web service 305 and may be coupled to output data to building specific classifier 316. Retraining classifier operation 242 may also access data in building specific anomalies database 332 and user feedback on anomalies database 334.

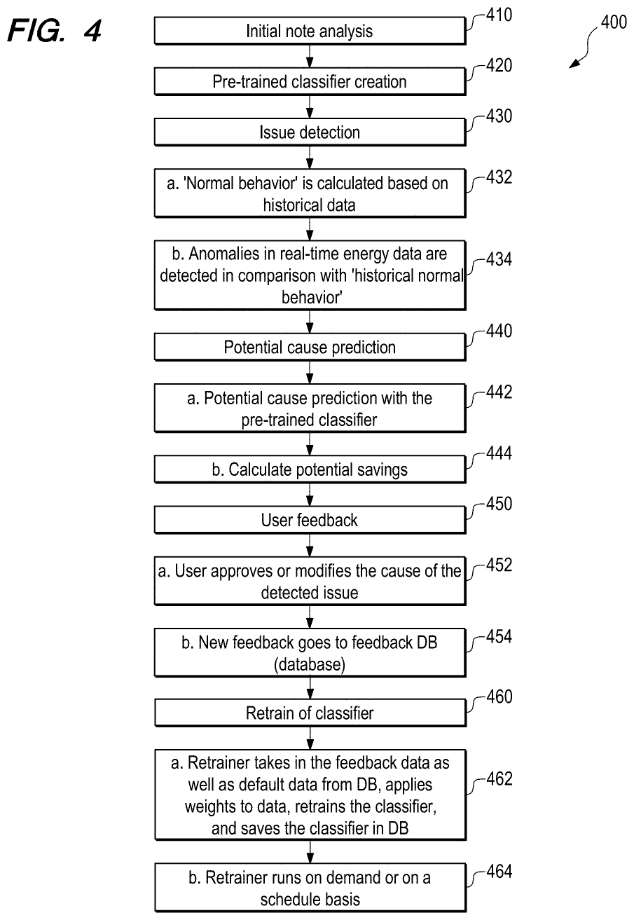

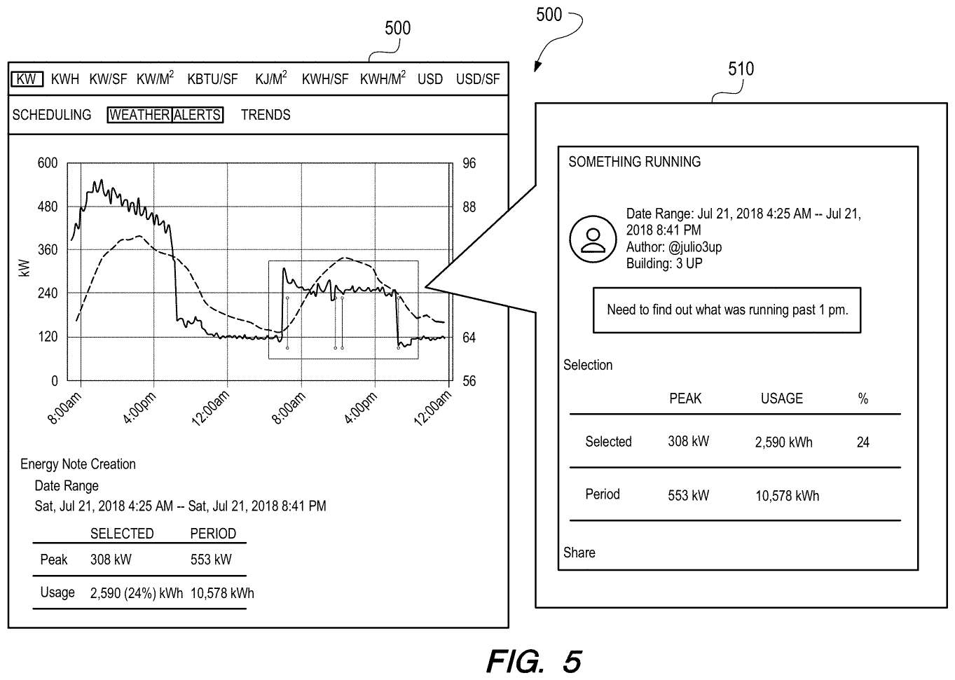

For brevity, the operation of process 200 and architecture 300 is described in further detail with respect to a routine 400 in FIG. 4 and further examples in FIGS. 5-22.

FIG. 4 is a flowchart diagram of a computer-implemented scalable self-learning method 400 for building operation and management according to an embodiment (steps 410-464).

Initial Note Analysis

In step 410, initial note analysis is performed. Text or other information in a note is parsed and analyzed to identify relevant topics for building management. These topics may correspond to automated categories or user-defined categories associated with different anomalies that impact building management. In one embodiment, initial note analysis 410 can be implemented in process 212 on system 300 as described above.

In a further feature, a note may be a digital note used as part of a computer-implemented tool with which users can record a digital message about their building operations. Notes can be taken and stored in digital form as part of an energy management system such as the platform available from Aquicore Inc. A note can be any descriptive input on a building. For example, everything from equipment malfunctions to tenant requests may be input in a note and associated with a building energy curve or profile. Users can add extra context like images or voice input and start a conversation with other building staff through communication capabilities (such as the @mentioning capabilities in an AQUICORE platform.)

FIG. 5 is a diagram that illustrates an example note according to an embodiment. FIG. 5 shows an example note 500 that a customer may create. A building engineer named “Julio” indicates he found an abnormal behavior on a date (say Jul. 21, 2018), and records his impressions “something was running” and “need to figure out what was running past 1 PM” because it was Saturday and the condition was not expected.

Like this, users can take notes on their day-to-day building operations where a building optimization is needed or being performed. Such notes can be collected and stored in an energy management system platform. In this way, an energy management system platform can draw from notes stored for different buildings and different engineers for years. In one feature, machine learning can be applied on thousands of notes or more to help identify key optimization areas that building engineers care about the most.

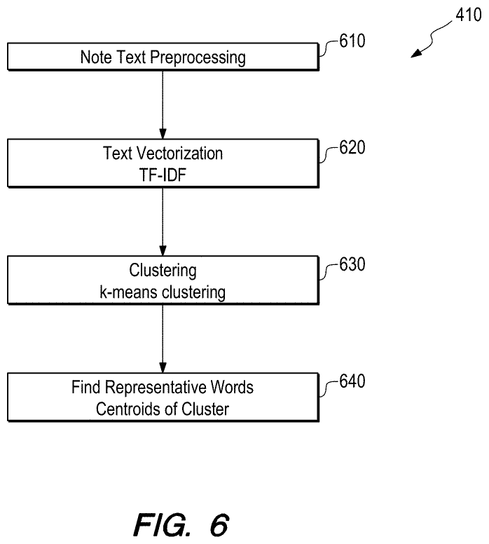

FIG. 6 is a flowchart diagram that illustrates an example process 410 in further detail.

In this embodiment, process 410 uses automated note taking clustering based on machine learning (steps 610-640). In step 610, text in a note is preprocessed. For example, text information of notes (title and body) are taken, combined, and cleaned. Cleaning includes converting texts into all lower-case letters or other desired format.

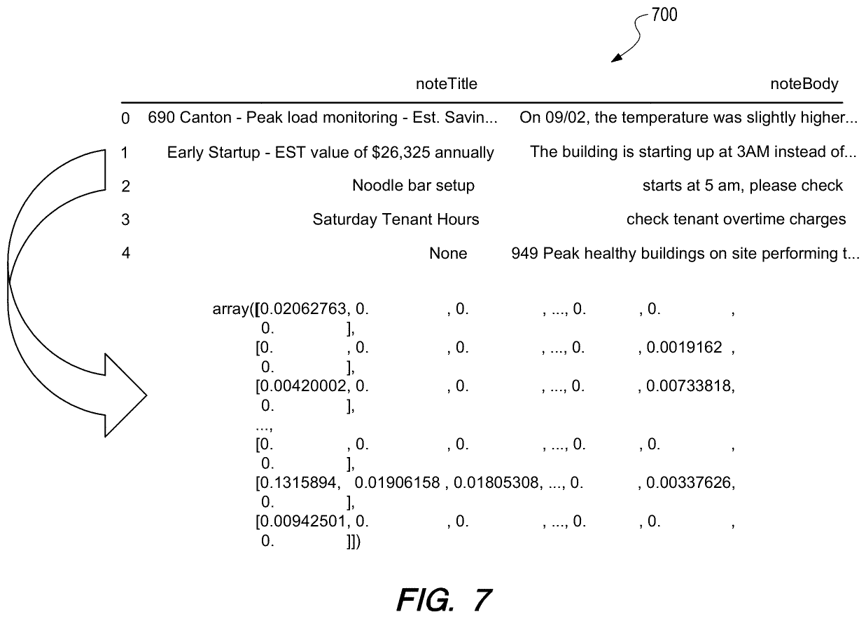

Next, in step 620, text vectorization is carried out. For example, the title and body of all the notes may be converted to a vectorized form using a Term Frequency-Inverse Document Frequency (TF-IDF) technique. FIG. 7 is a diagram 700 that illustrates an example of note text vectorization of title and body information into an array of vectors associated with respective text in the title and body of note according to an embodiment.

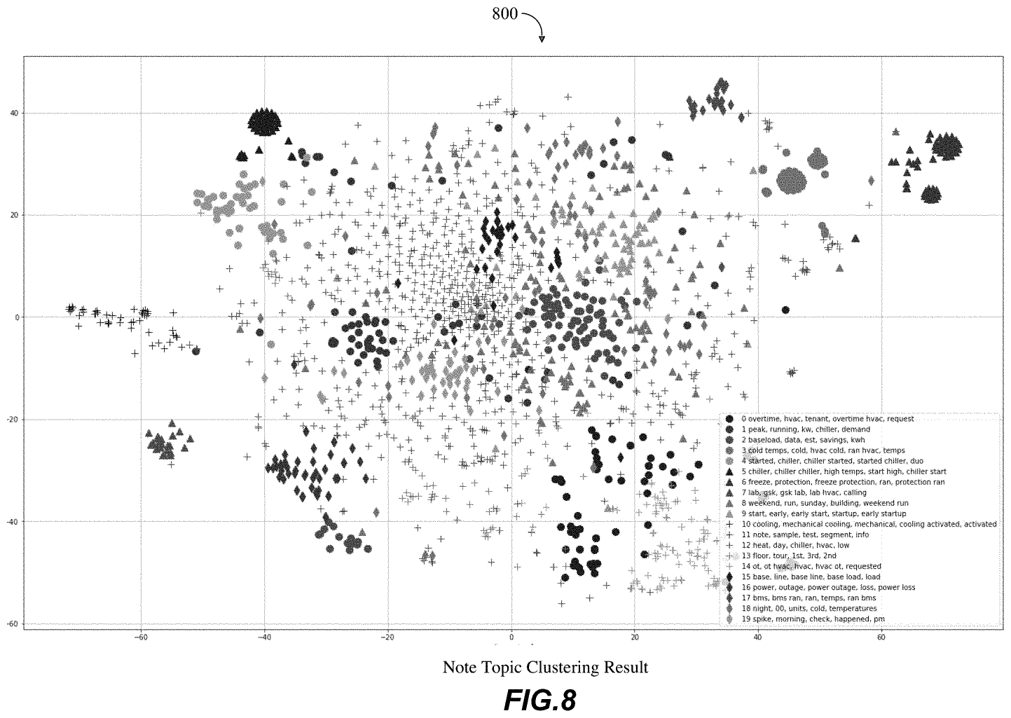

In step 630, clustering is carried based on the array of vectors obtained in step 620. For example, using a k-means clustering technique, a processor can find n different clusters of notes based on their distance from each other. FIG. 8 is a diagram 800 that illustrates an example result of note topic clustering according to an embodiment. In the scatterplot diagram 800, 20 different clusters of topics are plotted at spacings according to their relevant distance from one another (that is the degree of semantic difference or meaning in the topics from one another). For example, as shown in the legend, 20 clusters of topics are obtained for the following text obtained in notes:

| | |
|---|---|
| [symbol] | 0 overtime, hvac, tenant, overtime hvac, request |
| [symbol] | 1 peak, running, kw, chiller, demand |
| [symbol] | 2 baseload, data, est, savings, kwh |
| [symbol] | 3 cold temps, cold, hvac cold, ran hvac, temps |
| [symbol] | 4 started, chiller, chiller started, started chiller, duo |
| [symbol] | 5 chiller, chiller chiller, high temps, start high, chiller start |
| [symbol] | 6 freeze, protection, freeze protection, ran, protection ran |
| [symbol] | 7 lab, gsk, gsk lab, lab hvac, calling |
| [symbol] | 8 weekend, run, sunday, building, weekend run |
| [symbol] | 9 start, early, early start, startup, earty startup |
| + | 10 cooling, mechanical cooling, mechanical, cooling activated, |
| | activated |
| + | 11 note, sample, test, segment, info |
| + | 12 heat, day, chiller, hvac, low |
| + | 13 floor, tour, 1st, 3rd, 2nd |
| + | 14 ot, ot hvac, hvac, hvac ot, requested |
| [symbol] | 15 base, line, base line, base load, load |
| [symbol] | 16 power, outage, power outage, loss, power loss |
| [symbol] | 17 bms, bms ran, ran, temps, ran bms |
| [symbol] | 18 night, 00, units, cold, temperatures |
| [symbol] | 19 spike, morning, check, happened, pm |

In step 640, representative words are found for the clustered topics. The topics of each cluster are found based on the most representative words of each cluster. In one example, the most representative words are those matching words for the centroid of each cluster. In the initial note analysis here, text from an initial note being analyzed can also be added to corresponding topics determined from earlier note processing.

In one embodiment, initial note analysis 410 can be implemented in process 212 on system 300 as described above. Output from the initial note analysis (such as representative words found for the clustered topics) may be stored in default anomalies database 312.

In a further feature, a classification model (or simply classifier) is developed to predict and suggest optimal ways for users to operate their facilities by applying machine learning techniques. Embodiments of classifiers are described in further detail below.

Pre-Trained Classifier Creation

In step 420, a pre-trained classifier is generated. In one embodiment, pre-trained classifier creating step 420 can be implemented in process 214 on system 300 as described above. A pre-trained classifier created may be stored in pre-trained classifier database 314.

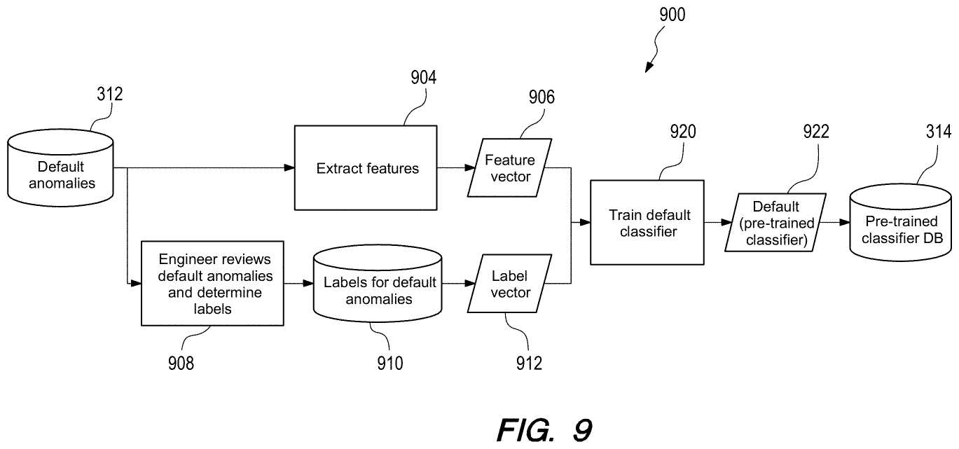

FIG. 9 is a flowchart diagram of a computer-implemented routine 900 for pre-trained classifier generation according to an embodiment (steps 904-922). In step 904, features are extracted from the data on anomalies stored in default database 312. In step 906, feature vectors are determined from the extracted features. The feature vectors are then used to train a default classifier (step 920). The default classifier (also called a pre-trained classifier) is then stored in pre-trained classifier database 314.

In a further feature, user-defined labels (or categories) may also be incorporated. In step 908, an engineer reviews default anomalies and determines labels. The engineer may make a selection or provide other types of user input to identify one or more user-defined labels for anomalies the engineer wishes to address in building management. These labels are stored in a database 910. Next, in step 912 label vectors are determined from the labels stored in database 910. The label vectors are then used along with the feature vectors to train a default classifier (step 920). The default classifier is then stored in pre-trained classifier database 314. In this way, a pre-trainer classifier may be created that takes into account features learned through automated processing of feature vectors and through labels learned through automated processing of label vectors corresponding to user-defined labels.

### Anomaly Detection

In step 430, an issue (also called an anomaly) is detected. In one embodiment, anomaly detection step 430 can be implemented in process 232 on system 300 as described above. Expected or normal behavior is calculated based on historical data for a building (step 432). Anomalies can be detected by comparing real-time sensor data with historical normal behavior for a target period (step 434).

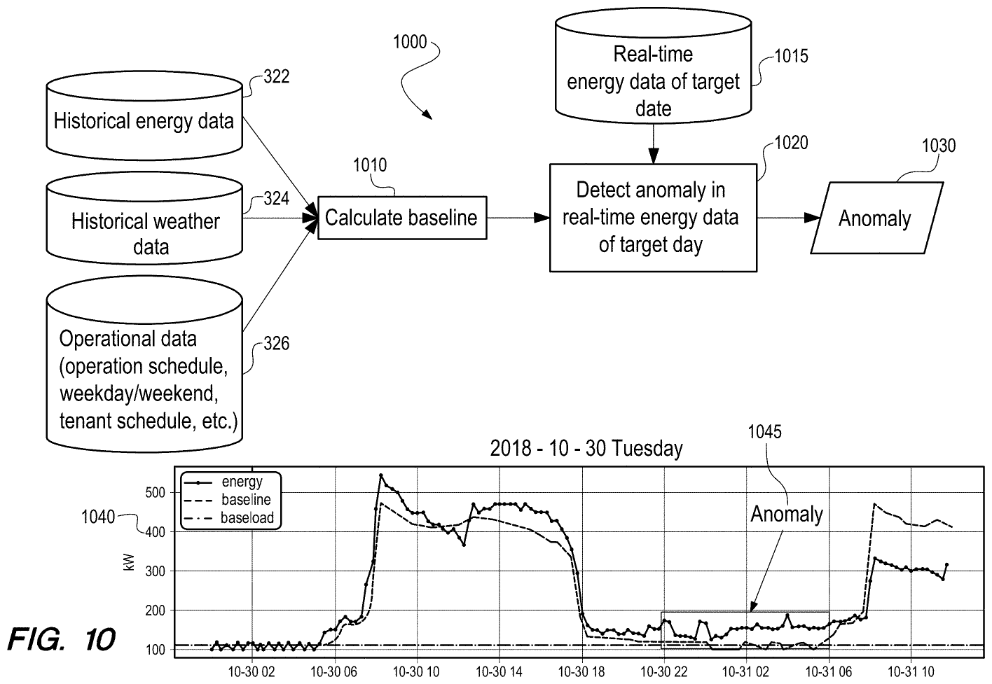

FIG. 10 is a flowchart diagram of a computer-implemented routine 1000 for anomaly detection in building management according to an embodiment (steps 1010-1030). In step 1010, a baseload and baseline usage pattern is calculated. This can be calculated based on data in one or more of databases 322-326. This may include historical energy data, historical weather data, or operational data (such as data on operation schedule, weekday/weekend, tenant schedule, etc.).

In step 1020, an anomaly is detected in real-time energy data of a target day or period. This anomaly for example may be detected by comparing real-time energy data of a target date in a database 1015 with the calculated baseload and baseline usage pattern. When the comparison exceeds a threshold or other criteria an anomaly is detected and output in step 1030. For example, as shown in FIG. 10, a plot 1040 shows data for a target date Oct. 30, 2018 comparing real-time energy usage against baseline and baseload data. An anomaly 1045 is detected for a portion of the period when real-time energy usage exceeds baseline and base load data by a predetermined threshold.

Potential Cause Prediction

In step 440, a potential cause is predicted for a detected anomaly. Potential cause may be predicted using a pre-trained classifier (step 442). Potential cost (or spend) may also be calculated (step 444). In one embodiment, cause prediction step 440 can be implemented in process 234 on system 300 as described above.

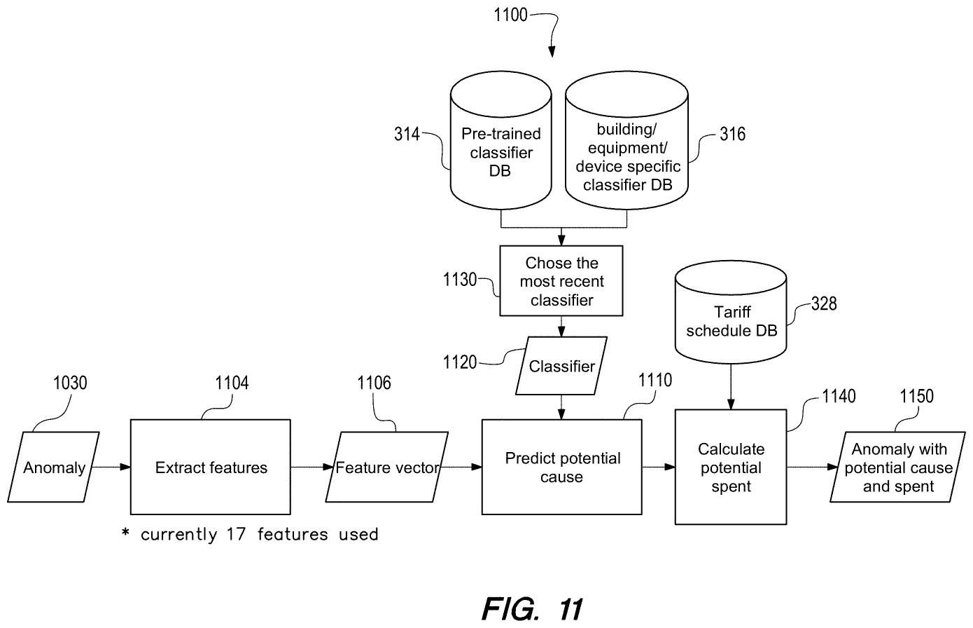

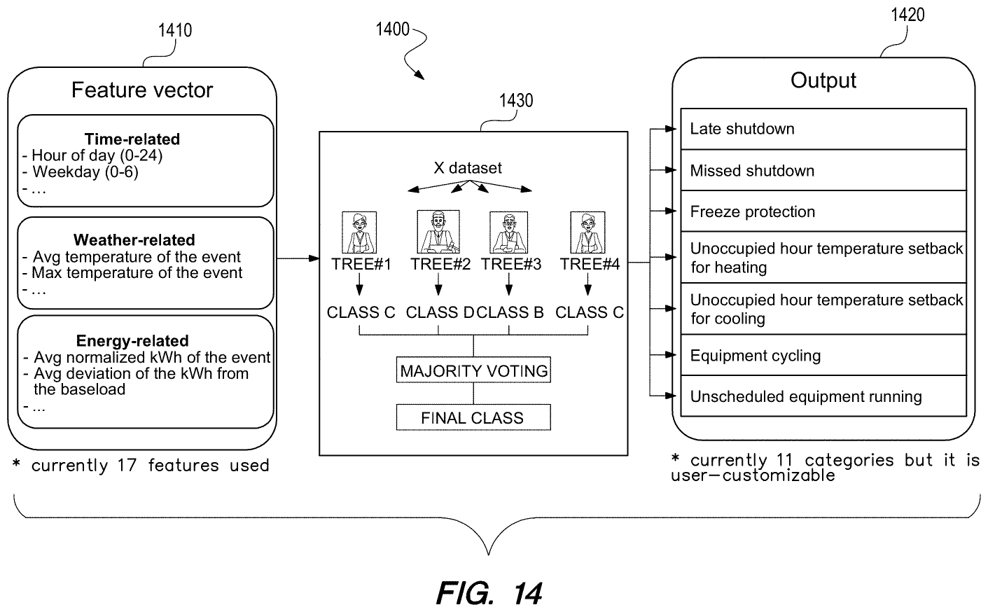

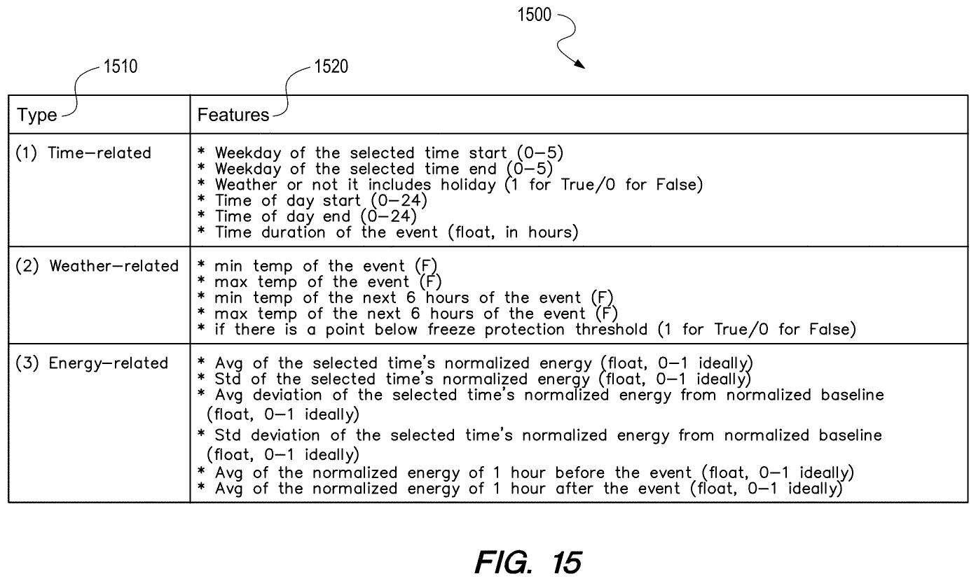

FIG. 11 is a flowchart diagram of a computer-implemented routine 1100 for potential cause prediction according to an embodiment (steps 1104-1150). In step 1104, features are extracted from the output anomaly 1030. In one test implementation, the inventors used 17 features relating to building management; however this is illustrative and a greater or smaller number of features may be used. In step 1106, an array of feature vectors are determined from the extracted features. FIG. 14 shows an example of an array 1410 of feature vectors. The feature vectors in the array are made up of processed data representing the relative values of features which are time-related, weather-related, and/or energy-related. FIG. 15 shows a table of 17 features used for three types of time-related, weather-related, and/or energy-related features in one example. These features are illustrative and not intended to be limiting. Different features may be used depending upon a particular application as would be apparent to a person skilled in the art given this description.

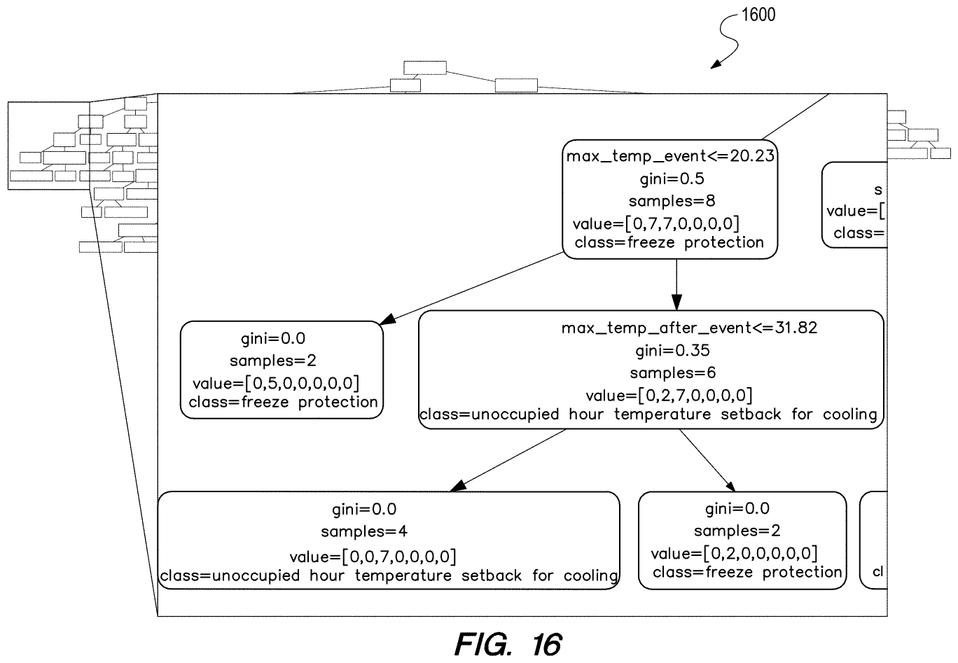

In step 1110, a potential cause is predicted by applying a classifier 1120 to the array of feature vectors. In one example, classifier 1120 is obtained in step 1130 by selecting the most recently used classifier from either pre-trained classifier database 314 or a building/equipment/device specific classifier database 316. For example, as shown in FIG. 14, a random forest classifier 1430 may be used. FIG. 16 shows in more detail an example of the decision structure and data applied in a random forest classifier 1600. This is illustrative and not intended to be limiting. Other types of classifiers, such as artificial neural network-based classifiers, may be used. The classifier then predicts one or more potential causes based on the array of feature vectors. For example, as shown in FIG. 14, applying classifier 1430 to array 1410 may obtain an output 1420 of potential predicted causes. The potential causes predicted for the detected anomaly where usage was high in a target period may be a late shutdown, missed shutdown, freeze protection, unoccupied hour temperature setback for heating or cooling, equipment cycling, or unscheduled equipment running.

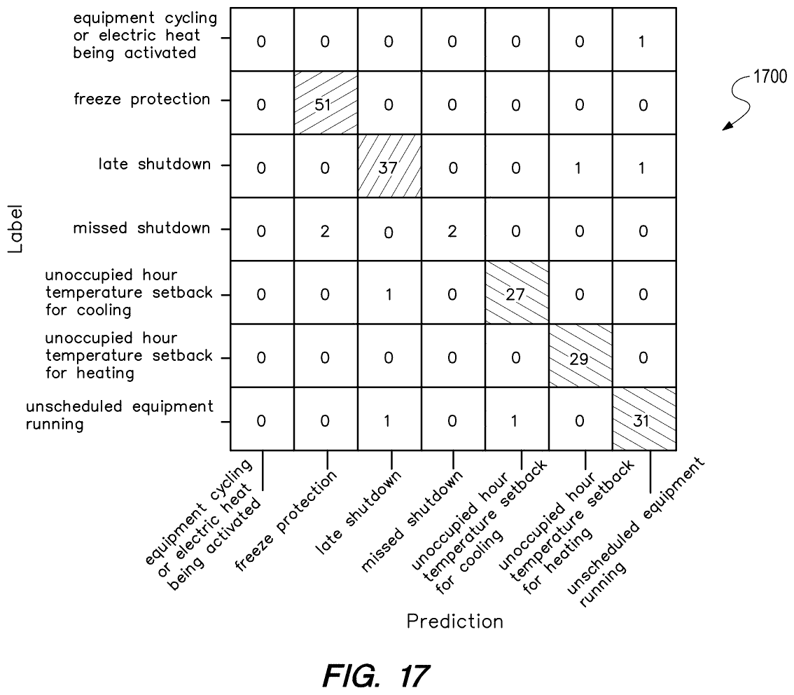

The classification test results shown in FIG. 17 are for an example test implementation. These test results show over 95% accuracy in predicting potential causes for a detected anomaly as described herein. These results can be improved even further with user feedback and retraining of a classifier over time.

Once a potential cause is predicted, a potential cost or spend associated with the cause may also be calculated (step 1140). This calculation of cost may also involve performing a lookup on a tariff schedule in tariff schedule database 328.

Data representative of the detected anomaly with the potential cause prediction and calculated spent is then output (step 1150).

User Feedback

In step 450, user feedback is provided. In step 452, a user may approve or modify a potential cause predicted for a detected anomaly in step 440. In step 454, information on a user's approval or modification is then sent as feedback to an anomaly feedback database 334. In one embodiment, user feedback step 450 can be implemented in process 236 on system 300 as described above.

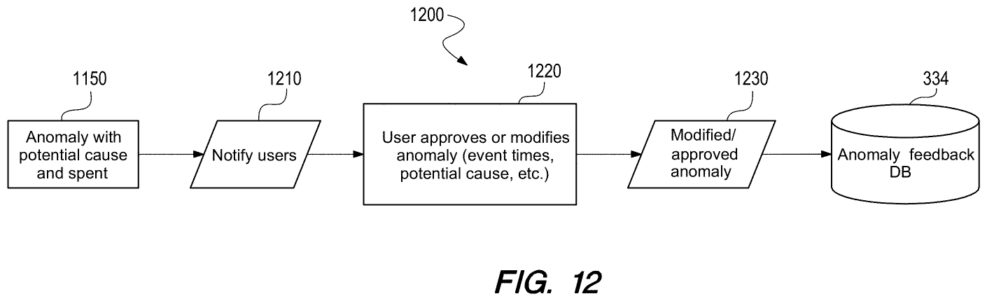

FIG. 12 is a flowchart diagram of a computer-implemented routine 1200 for providing user feedback according to an embodiment (steps 1210-1230). In step 1210, designated users for a building may be notified of an anomaly 1150 output with a potential cause predicted and spent calculated. For example, notifications about an output anomaly 1150 may be sent to users through a web application, mobile application or other messaging application. In step 1220, each user that receives a notification may approve or modify the anomaly or cause predicted. For example, a user may modify event times, the identified potential cause, or other pertinent information. This can be done through a user-interface or other input technique. In step 1230, the modified or approved anomaly feedback from a user is then sent over a network for storage in anomaly feedback database 334. In this way, accuracy may be increased.

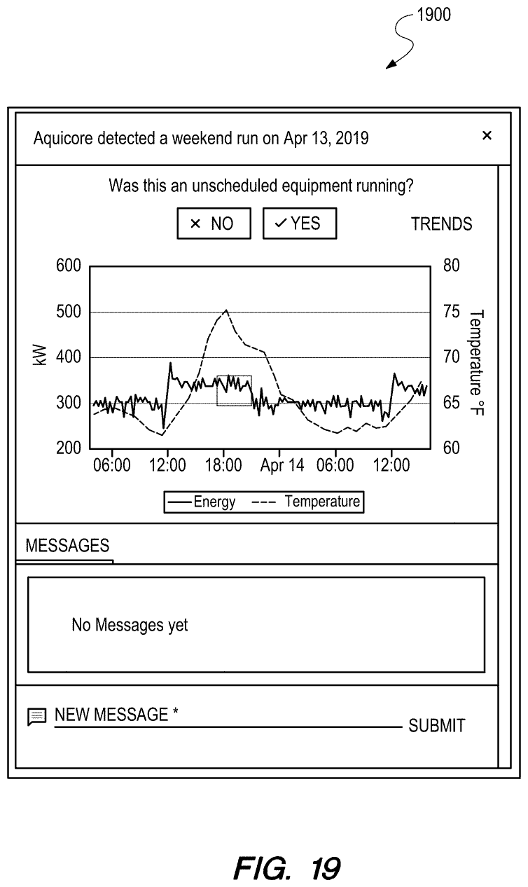

FIG. 19 shows an example display panel 1900 that may be sent to a user to provide information about an anomaly detected with automated anomaly detection. Panel 1900 may include a display area to show data with an anomaly highlighted as shown. A query and response buttons or input boxes may be included to allow a user to affirm or deny a potential cause prediction. In this case, a query asks if unscheduled equipment was running? A user may then select a button to provide a yes or no response as user feedback. A subpanel or other area may be provide to allow a user to read a message or submit a new message.

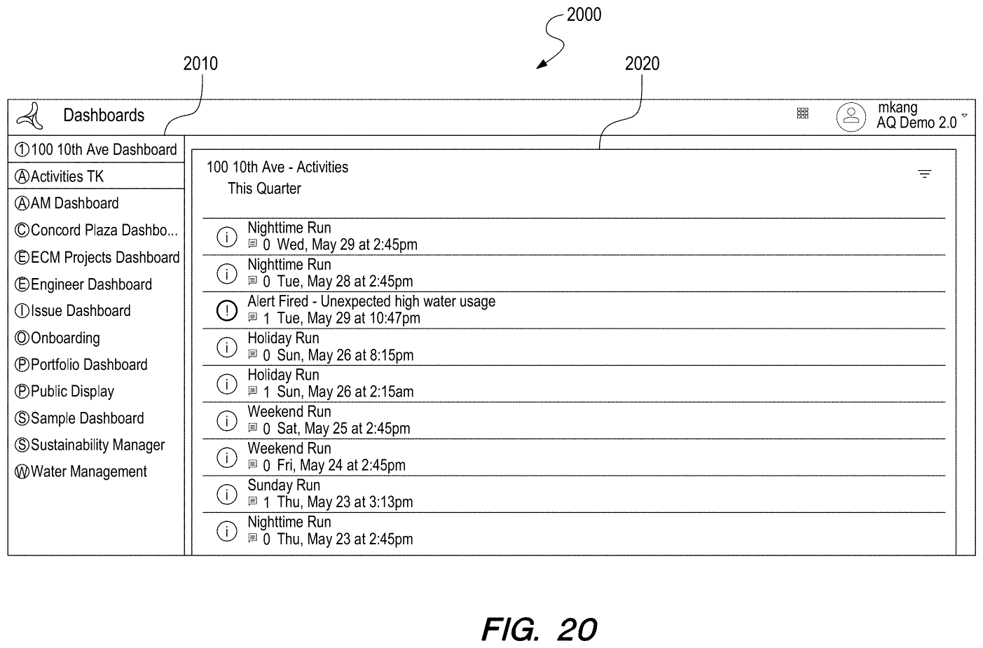

FIG. 20 shows a display panel providing a dashboard view 2000 of a list of dashboards 201 and activities 2020. Activities list 2020 includes a “nighttime run” for a particular property at “100 10^{th} Ave. The nighttime run had an anomaly detected with automated anomaly detection.

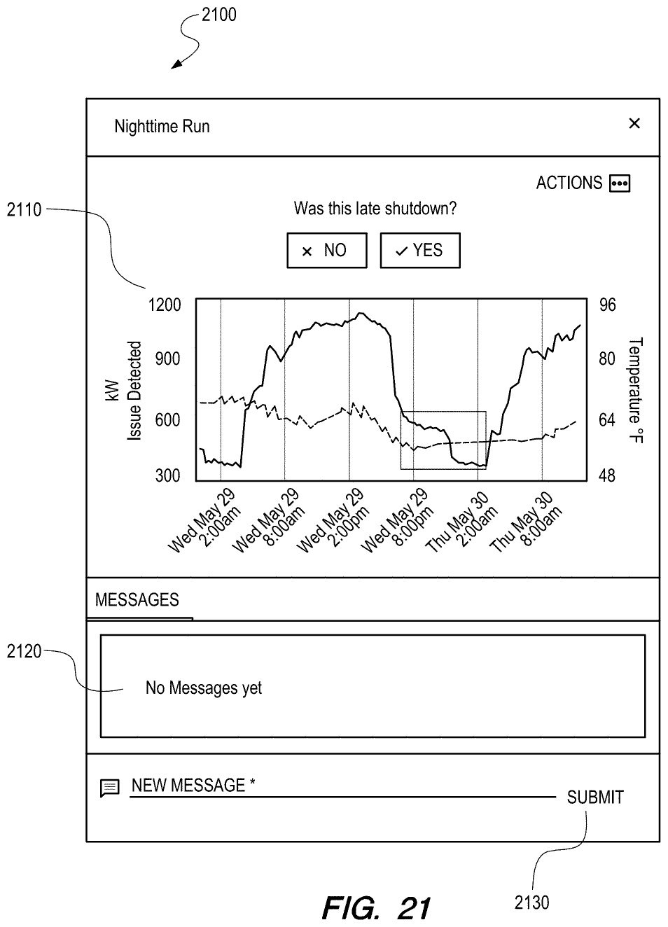

FIG. 21 shows an example display panel 2100 displaying information on the nighttime run selected from the dashboard view of FIG. 20. Panel 2100 includes a display area 2110 to show data with a detected anomaly highlighted. A query and response buttons or input boxes may be included to allow a user to affirm or deny a potential cause prediction. In this case, a query asks if this was a late shutdown? A user may then select a button to provide a yes or no response as user feedback. A subpanel or other area may be provide to allow a user to read a message or submit a new message. In this way, a user can review events, message or tag others, and acknowledge or modify a potential cause prediction.

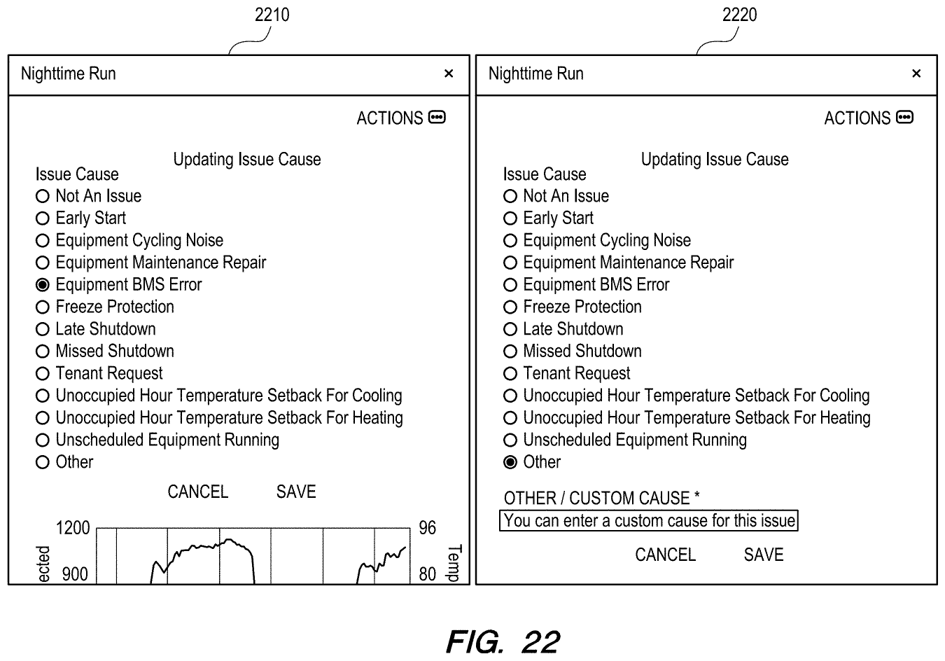

FIG. 22 shows example display panels 2210 and 2220 with radio buttons that enable a user to input an action to update an issue cause associated with the run displayed in FIG. 21. In panel 2210, a user inputs an equipment BMS error to update an issue cause. In panel 2220, a user inputs an “other” designation to update an issue cause.

### Retraining Classifier

In step 460, retraining of a classifier is provided. In step 462, a classifier retrainer takes in user feedback data as well as default data. Weights may be applied to the data. A classifier retrainer may be run on demand or on a scheduled basis (step 464).

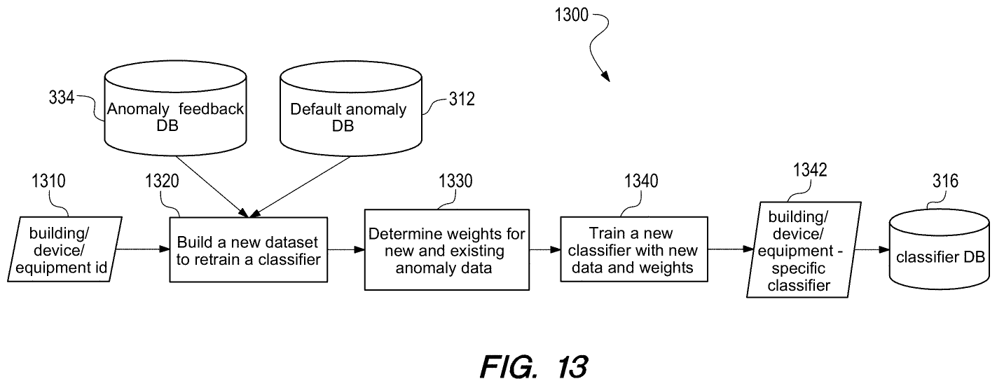

FIG. 13 is a diagram that illustrates retraining of a classifier according to an embodiment (steps 1310-1342). In step 1310, building/device/equipment identification (ID) data is accessed. A new dataset is then built to retrain a classifier (step 1320). The new dataset may include data drawn from building/device/equipment identification (ID) data, anomaly feedback database 334, and default anomaly database 312. In step 1330, weights are determined for new and existing anomaly data. In step 1340, a new classifier is trained with the new dataset and weights to obtain a new building/device/equipment specific classifier (step 1342). The new building/device/equipment specific classifier is then stored in classifier database 316.

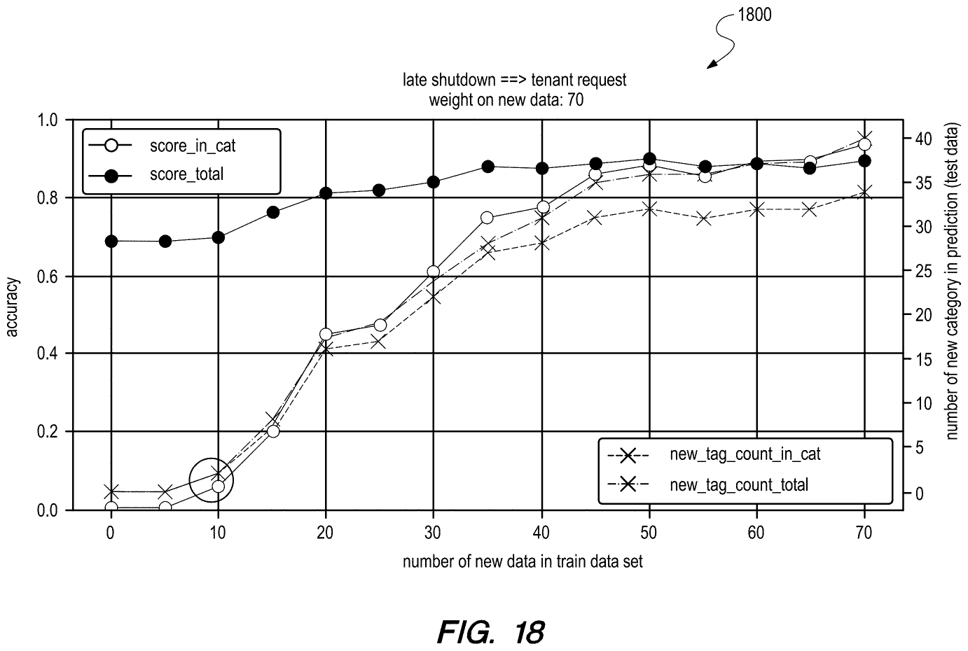

FIG. 18 shows an example of user feedback in operation. In this example, a user provides an actual cause of an issue as user feedback. Every day (or on a periodic basis), a controller checks if there is user feedback. If there is a new user feedback, retraining classifier runs to create a new classifier. Higher weights are applied on the new data compared to older data. After a few samples (5-10) of a similar pattern, as the plots in FIG. 18 shows a new and more accurate category of potential cause is predicted.

### Example Computer-Implemented Energy Management Service Implementations

Automatic diagnostics as described herein can be implemented on or more computing devices. Computer-implemented functions and operations described above and with respect to embodiments shown in FIGS. 1-22 can be implemented in software, firmware, hardware or any combination thereof on one or more computing devices.

Example computing devices include, but are not limited to, any type of processing device including, but not limited to, a computer, workstation, distributed computing system, embedded system, stand-alone electronic device, networked device, mobile device (such as a smartphone, tablet computer, or laptop computer), set-top box, television, or other type of processor or computer system having at least one processor and computer readable memory. In further embodiments, automatic diagnostics as described herein can be implemented on a server, cluster of servers, server farm, or other computer-implemented processing arrangement operating on or more computing devices.

Automatic diagnostics as described herein can be implemented on or more computing devices coupled to and part of an energy management system that can receive and process notes from different users. In one example, users can provide notes through browsers on mobile devices. A mobile device may include a web browser for communicating with a web server. Any type of browser may be used including, but not limited to, Internet Explorer available from Microsoft Corp., Safari available from Apple Corp., Chrome browser from Google Inc., Firefox, Opera, or other type of proprietary or open source browser. A browser is configured to request and retrieve resources, such as web pages that provide options to configure and carry out aspects of note input using a web browser.

In one embodiment, not intended to be limiting, an energy management system can be a computer-implemented energy management service or platform available from Aquicore Inc. In further embodiments, an energy management service can include, but is not limited to, a configurable energy management service described in application Ser. No. 14/449,893 incorporated in its entirety herein by reference. In one embodiment, an energy management service can be a centralized online platform for managing energy usage of a building. Metering and/or sub-metering can be managed depending upon an application.

An energy management service configured to carry out automatic diagnostics as described herein including web service 305 and cloud storage 310 may include a web server (not shown). Web server may be configured to accept requests for resources from client devices, such as web pages and send responses back to client devices. Any type of web server may be used including, but not limited to, Apache available from the Apache Project, IIS available from Microsoft Corp., nginx available from NGINX Inc., GWS available from Google Inc., or other type of proprietary or open source web server. A web server may also interact with a remote server. A user can use a mobile device or other computing device to configure and access services provided by an energy management service.

For example, after configuration, a user may access subscribed energy management modules by using a web browser. For example, the user may use a web browser to view energy management information (e.g., energy data, graphs, or charts) prepared by a subscribed energy management module. The web browser may send a HTTP request to a web server. The energy data, graphs, or charts may be transmitted to web browser via HTTP responses sent by web server.

A user may also access subscribed energy management modules by using a standalone client application on a client computing device (e.g., mobile device 130). In one embodiment, a client application communicates directly with a subscribed energy management module to obtain the energy data prepared by the subscribed energy management module. In another embodiment, a client application communicates with subscription manager to obtain the energy management information prepared by the subscribed energy management module. In some embodiments, client application requests and receives energy data through RESTful API. In other embodiments, a client application may utilize other communication architectures or protocols to request and receive the energy management information. These communication architectures or protocols include, but are not limited to, SOAP, CORBA, GIOP, or ICE. The display of energy data by standalone client application may be further customized depending on the user's special needs.

Embodiments are also directed to computer program products comprising software stored on any computer-usable medium. Such software, when executed in one or more data processing devices, causes a data processing device(s) to operate as described herein or, as noted above, allows for the synthesis and/or manufacture of electronic devices (e.g., ASICs, or processors) to perform embodiments described herein. Embodiments employ any computer-usable or -readable medium, and any computer-usable or -readable storage medium known now or in the future. Examples of computer-usable or computer-readable mediums include, but are not limited to, primary storage devices (e.g., any type of random access memory), secondary storage devices (e.g., hard drives, floppy disks, CD ROMS, ZIP disks, tapes, magnetic storage devices, optical storage devices, MEMS, nano-technological storage devices, etc.), and communication mediums (e.g., wired and wireless communications networks, local area networks, wide area networks, intranets, etc.). Computer-usable or computer-readable mediums can include any form of transitory (which include signals) or non-transitory media (which exclude signals). Non-transitory media comprise, by way of non-limiting example, the aforementioned physical storage devices (e.g., primary and secondary storage devices).

The embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the embodiments that others can, by applying knowledge within the skill of the art, readily modify and/or adapt for various applications such specific embodiments, without undue experimentation, without departing from the general concept of the disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the embodiments should not be limited by any of the above-described exemplary embodiments, but should be defined only in accordance with the following claims and their equivalents.

What is claimed is:

1. A computer-implemented method for providing automatic diagnostics of energy management in a building, comprising:
storing note information in a database, the note information including data extracted from notes input by users of an energy management system;
processing the stored note information including clustering note topics and building a classification model; and
automatically categorizing an issue based on the clustered note topics and the built classification model.

2. The method of claim 1, further comprising:
enabling a user to define categories; and
updating the classification model according to the user-defined categories.

3. The method of claim 1, further comprising automatically generating an output note based on the clustered note topics and the built classification model.

4. A system for providing automatic diagnostics of energy management in a building, comprising:
a database configured to store note information, the note information including data extracted from notes input by users of an energy management system; and
at least one processor coupled to the database and configured to process the stored note information including configured to cluster note topics and build a classification model, and further configured to automatically categorize an issue based on the clustered note topics and the built classification model.

5. The system of claim 4, wherein the at least one processor is further configured to enable a user to define categories, and wherein the at least one processor is configured to update the classification model according to the user-defined categories.

6. The system of claim 4, wherein the at least one processor is further configured to automatically generate an output note based on the clustered note topics and the built classification model.

7. A non-transitory computer-readable medium, having instructions stored thereon, that when executed by at least one processor, cause the at least one processor to perform the following operations for providing automatic diagnostics of energy management in a building, comprising:
storing note information in a database, the note information including data extracted from notes input by users of an energy management system;
processing the stored note information including clustering note topics and building a classification model; and
automatically categorizing an issue based on the clustered note topics and the built classification model.

8. The non-transitory computer-readable medium claim 7, wherein the operations further comprise:
enabling a user to define categories; and
updating the classification model according to the user-defined categories.

9. The non-transitory computer-readable medium claim 7, wherein the operations further comprise automatically generating an output note based on the clustered note topics and the built classification model.

10. A scalable self-learning method for building operation and management comprising:
creating a generic anomaly detection and classification machine learning model based on a general training dataset;
deploying the model in a cloud server;
creating a copy of the model for each individual building/equipment/device of a user;
detecting and classifying anomalies from real-time sensor data based off of the model; and
continuously updating the model based on a user's feedback about the detection and classification.

11. A scalable self-learning system having one or more processors for performing the method of claim 10.

12. A non-transitory computer-readable medium, having instructions stored thereon, that when executed by at least one processor, cause the at least one processor to:
create a generic anomaly detection and classification machine learning model based on a general training dataset;
deploy the model in a cloud server;
create a copy of the model for each individual building/equipment/device of a user;
detect and classify anomalies from real-time sensor data based off of the model; and
continuously update the model based on a user's feedback about the detection and classification.
